(19) United States
(12) Patent Application Publication
(10) Pub. No.: US 2021/0385610 A1
(43) Pub. Date: Dec. 9, 2021

(54) DETERMINING GEOFENCE BASED ON USER LOCATIONS

(71) Applicant: BEIJING SANKUAI ONLINE TECHNOLOGY CO., LTD., Beijing (CN)

(72) Inventors: Zhiqiang ZHANG, Beijing (CN); Biao GAN, Beijing (CN); Qiuwei DING, Beijing (CN)

(21) Appl. No.: 17/407,905

(22) Filed: Aug. 20, 2021

Related U.S. Application Data
(63) Continuation of application No. PCT/CN2019/120218, filed on Nov. 22, 2019.

(30) Foreign Application Priority Data
Feb. 20, 2019 (CN) 201910127295.1

(51) Int. Cl. H04W 4/021; H04W 64/00; H04W 4/029

(52) U.S. Cl. CPC H04W 4/021; H04W 4/029; H04W 64/003

(57) ABSTRACT

A method of determining a geofence based on user locations belongs to the field of computer technologies. The method of determining a geofence based on user locations includes: obtaining user locations in a plurality of pieces of user data; aggregating the user locations according to similarities in latitude and longitude coordinates of the user locations, to determine aggregation points and a central aggregation point; denoising the aggregation points according to distances between the aggregation points and the central aggregation point; and sorting, according to values of longitude coordinates or latitude coordinates, aggregation points obtained after the denoising, to determine geofence boundary data in a preset format.

This application claims priority to Chinese Patent Application No. 201910127295.1, entitled “METHOD AND APPARATUS OF DETERMINING GEOFENCE BASED ON USER LOCATIONS AND ELECTRONIC DEVICE” filed with the China National Intellectual Property Administration on Feb. 20, 2019, which is incorporated herein by reference in its entirety.

### TECHNICAL FIELD

This application relates to the field of computer technologies, and in particular, to determining a geofence based on user locations.

### BACKGROUND

A geofence is a virtual geographic boundary, which represents a geographic location region. When a user device enters or exits the region, a corresponding geofence event is triggered. An application program can capture a geofence event of interest and perform corresponding operations. A shape of the geofence may be a circle formed by points and a radius, or a polygon formed by a batch of latitude and longitude points. The determination of the geofence has great value.

In the related art, a method of determining a geofence is usually as follows: performing cluster analysis on latitude and longitude coordinates, to obtain one or more latitude and longitude coordinate clusters, each latitude and longitude coordinate cluster including a plurality of latitude and longitude coordinates, and generating a geofence based on boundary points of the latitude and longitude coordinate clusters. However, when a person skilled in the related art clusters the latitude and longitude coordinates, a method such as a K-Means algorithm for data aggregation is complex and inefficient, an initial clustering center needs to be specified, and a minimum threshold of a cluster and other manual intervention data need to be specified, which is not intelligent enough and requires excessive manual intervention, resulting in loss of accuracy of the geofence.

### SUMMARY

According to a first aspect, an embodiment of this application provides a method of determining a geofence based on user locations, including:

obtaining user locations in a plurality of pieces of user data;

aggregating the user locations according to similarities in latitude and longitude coordinates of the user locations, to determine aggregation points and a central aggregation point;

denoising the aggregation points according to distances between the aggregation points and the central aggregation point; and

sorting, according to values of longitude coordinates or latitude coordinates, aggregation points obtained after the denoising, to determine geofence boundary data in a preset format.

According to a second aspect, an embodiment of this application provides an apparatus of determining a geofence based on user locations, including:

a user location obtaining module, configured to obtain user locations in a plurality of pieces of user data;

an aggregation module, configured to aggregate the user locations according to similarities in latitude and longitude coordinates of the user locations, to determine aggregation points and a central aggregation point;

a denoising module, configured to denoise the aggregation points according to distances between the aggregation points and the central aggregation point; and

a geofence construction module, configured to sort, according to values of longitude coordinates or latitude coordinates, aggregation points obtained after the denoising, to determine geofence boundary data in a preset format.

According to a third aspect, an embodiment of this application further discloses an electronic device, including a memory, a processor, and a computer program stored in the memory and capable of being run on the processor, the processor, when executing the computer program, implementing the method of determining a geofence based on user locations according to the embodiments of this application.

According to a fourth aspect, an embodiment of this application provides a computer-readable storage medium, storing a computer program, the program, when executed by a processor, implementing the steps of the method of determining a geofence based on user locations disclosed in the embodiments of this application.

In the method of determining a geofence based on user locations disclosed in the embodiments of this application, user locations in a plurality of pieces of user data are obtained; the user locations are aggregated according to similarities in latitude and longitude coordinates of the user locations, to determine aggregation points and a central aggregation point; the aggregation points are denoised according to distances between the aggregation points and the central aggregation point; and aggregation points obtained after the denoising are sorted according to values of longitude coordinates or latitude coordinates, to determine geofence boundary data in a preset format. Therefore, a problem of loss of accuracy of a geofence caused by manual intervention to set cluster parameters during clustering of geographic locations in the related art is resolved. In the method of determining a geofence based on user locations disclosed in the embodiments of this application, location aggregation is performed according to the similarities in the latitude and longitude coordinates of the user locations, and effective user location data is automatically determined according to an aggregation result. Subsequently, the boundary data in the preset format is determined based on the effective user location data, thereby obtaining a geofence without any manual intervention, which helps to improve the accuracy of the geofence.

### BRIEF DESCRIPTION OF THE DRAWINGS

To describe the technical solutions of the embodiments of this application more clearly, the following briefly introduces the accompanying drawings required for describing the embodiments or the related art. Apparently, the accompanying drawings in the following description show only some embodiments of this application, and a person of ordinary skill in the art may still derive other drawings from these accompanying drawings without creative efforts.

FIG. 1 is a flowchart of a method of determining a geofence based on user locations according to an embodiment of this application;

FIG. 2 is a first schematic structural diagram of an apparatus of determining a geofence based on user locations according to an embodiment of this application;

FIG. 3 is a second schematic structural diagram of an apparatus of determining a geofence based on user locations according to an embodiment of this application;

FIG. 4 is a block diagram of an electronic device for performing the method according to this application; and

FIG. 5 shows storage units for holding or carrying program code for implementing the method according to this application.

### DETAILED DESCRIPTION OF THE EMBODIMENTS

The technical solutions in embodiments of this application are clearly and completely described in the following with reference to the accompanying drawings in the embodiments of this application. Apparently, the described embodiments are some rather than all of the embodiments of this application. All other embodiments obtained by a person of ordinary skill in the art based on the embodiments of this application without making creative efforts shall fall within the protection scope of this application.

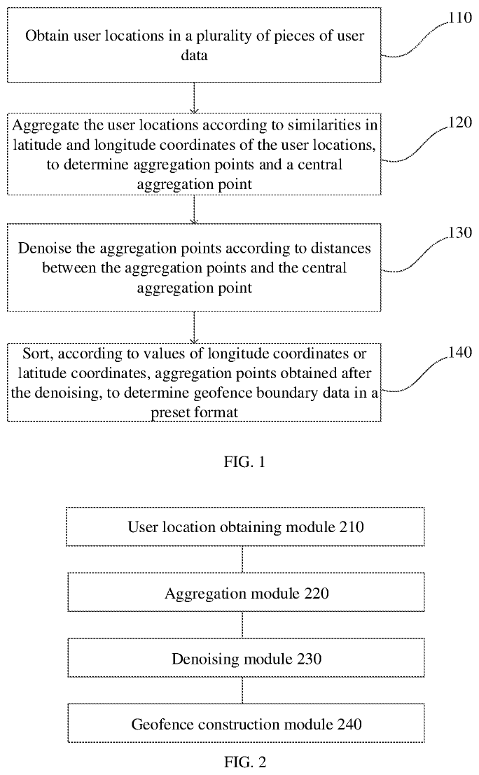

A method of determining a geofence based on user locations disclosed in this embodiment is shown in FIG. 1. The method includes step 110 to step 140.

Step 110. Obtain user locations in a plurality of pieces of user data.

The method of determining a geofence based on user locations disclosed in this embodiment of this application may be used in applications of determining a geofence for a business district, geofences of services such as food delivery and tourism, and a geofence that needs to be determined based on location services. During specific implementation, the user data may be food ordering data, wireless access point link data, hotel reservation data, ticket reservation data, information query data, and the like of a user that can be obtained by a service platform. Generally, the user data includes user location information. By analyzing the data obtained by the platform, a plurality of pieces of user location information may be obtained.

The user location described in this embodiment of this application is represented by latitude and longitude coordinates, and the user location information includes longitude coordinates and latitude coordinates of the user location. For some data that represents the user location in other forms, the data may be first converted into data represented by latitude and longitude coordinates.

In a specific application, when a geofence needs to be determined for a specific application, preferably, user location analysis based on user data related to the specific application helps to improve accuracy of the determined geofence. In some embodiments of this application, the step of obtaining user locations in a plurality of pieces of user data includes: obtaining, according to creation conditions of a geofence, user data matching the creation conditions; and obtaining a user location in the user data. The creation conditions of the geofence include, but are not limited to: accuracy, a geographical area, and a category of the geofence. The category is used for indicating an application scenario of the geofence, including: a geofence for a popular food ordering business district, a geofence for a popular scenic spot, and a geofence for an administrative business district.

A food delivery application scenario is used as an example. A geofence for a popular food ordering merchant may be constructed, and food delivery orders are dispatched based on a determined geofence. For example, a specific food delivery person is responsible for food delivery for merchants within a specific geofence. Alternatively, a message is pushed to a user based on the geofence. After the user enters a geofence, information matching the geofence is pushed to the user. In this application scenario, the category of the geofence may be considered as the geofence for a popular food ordering business district. Further, the food ordering data of the user may be obtained for analysis, and a user location in each piece of food ordering data is determined.

Step 120. Aggregate the user locations according to similarities in latitude and longitude coordinates of the user locations, to determine aggregation points and a central aggregation point.

The latitude and longitude coordinates described in this embodiment of this application include longitude coordinates and latitude coordinates.

In the specific implementation of this application, the user locations are aggregated according to the similarities in the latitude and longitude coordinates of the user locations, to determine the aggregation points and the central aggregation point, and a plurality of aggregation points, a quantity of user locations aggregated in each aggregation point, and the central aggregation point corresponding to the plurality of aggregation points are determined. In some embodiments of this application, aggregating the user locations according to similarities in latitude and longitude coordinates of the user locations, to determine aggregation points and a central aggregation point includes: aggregating the user locations according to the similarities in the latitude and longitude coordinates of the user locations, to determine the plurality of aggregation points; and determining an aggregation point that aggregates the largest quantity of user locations as the central aggregation point.

Aggregating the user locations according to similarities in latitude and longitude coordinates of the user locations, to determine aggregation points and a central aggregation point may be implemented in the same manner. In the embodiments of this application, only three specific implementations are exemplified to assist readers in understanding the technical solutions of this application. A person skilled in the art can further use, based on a design idea of this application, other technical means to aggregate the user locations according to the similarities in the latitude and longitude coordinates of the user locations, to determine the aggregation points and the central aggregation point, and the technical means exemplified in this embodiment of this application should not be construed as a limitation on the technical means for aggregating the user locations according to the similarities in the latitude and longitude coordinates of the user locations, to determine the aggregation points and the central aggregation point.

In a first aggregation manner, the step of aggregating the user locations according to similarities in latitude and longitude coordinates of the user locations, to determine aggregation points and a central aggregation point includes: aggregating user locations that satisfy a preset latitude and longitude coordinate similarity condition into the same aggregation point, to determine a plurality of aggregation points; and determining an aggregation point in the plurality of aggregation points that aggregates the largest quantity of user locations as the central aggregation point, where the preset latitude and longitude coordinate similarity condition is as follows: three digits before decimal points of the longitude coordinates are the same, N digits after the decimal points of the longitude coordinates are the same, two digits before decimal points of the latitude coordinates are the same, and M digits after the decimal points of the latitude coordinates are the same, N and M being positive integers less than or equal to 5.

For example, latitude and longitude coordinates within 1 meter are used as similar coordinates, and the latitude and longitude coordinate similarity condition is determined as follows: three digits before the decimal points of the longitude coordinates are the same, five digits after the decimal points of the longitude coordinates are the same, two digits before the decimal points of the latitude coordinates are the same, and the five digits after the decimal points of the latitude coordinates are the same. Subsequently, for a plurality of obtained user locations, user locations with the same three digits before the decimal points of the longitude coordinates, the same five digits after the decimal points of the longitude coordinates, the same two digits before the decimal points of the latitude coordinates, and the same five digits after the decimal points of the latitude coordinates are aggregated into one category to obtain a plurality of user location categories. All user locations aggregated in each user location category have the same three digits before the decimal points of the longitude coordinates, the same five digits after the decimal points of the longitude coordinates, the same two digits before the decimal points of the latitude coordinates, and the same five digits after the decimal points of the latitude coordinates. During specific implementation, a longitude coordinate that is determined according to three digits before the decimal points of the longitude coordinates and five digits after the decimal points of the longitude coordinates of all user locations aggregated in each user location category may be used as a longitude coordinate of an aggregation point corresponding to the user location category, and a latitude coordinate that is determined according to two digits before the decimal points of the latitude coordinates and five digits after the decimal points of the latitude coordinates of all user locations aggregated in the each user location category may be used as a latitude coordinate of the aggregation point corresponding to the user location category, so that latitude and longitude coordinates of the aggregation point corresponding to the each user location category are determined. So far, through aggregation, a plurality of aggregation points are obtained, and latitude and longitude coordinates of each aggregation point, and a quantity of user locations aggregated in the aggregation point are determined.

Next, the aggregation point that aggregates the largest quantity of user locations is determined as the central aggregation point.

In some other embodiments of this application, if latitude and longitude coordinates within 10 meters are used as similar coordinates, the latitude and longitude coordinate similarity condition is determined as follows: three digits before the decimal points of the longitude coordinates are the same, four digits after the decimal points of the longitude coordinates are the same, two digits before the decimal points of the latitude coordinates are the same, and four digits after the decimal points of the latitude coordinates are the same. That is, aggregation accuracy requirements are different, so the latitude and longitude coordinate similarity condition is also different.

In this embodiment of this application, the user locations are directly aggregated based on the latitude and longitude coordinates with the same digits. The aggregation operation has low complexity, fast operation speed, and higher efficiency. In addition, during aggregation based on the similarities in the latitude and longitude coordinates, the latitude and longitude similarity condition can be flexibly and intuitively set according to an application scenario or a construction requirement of a geofence, which is more practical.

In a second aggregation manner, the step of aggregating the user locations according to similarities in latitude and longitude coordinates of the user locations, to determine aggregation points and a central aggregation point includes: performing GeoHash conversion on the latitude and longitude coordinates of the user locations, and determining a GeoHash code corresponding to each user location; aggregating user locations that satisfy a preset GeoHash code similarity condition into the same aggregation point, to determine a plurality of aggregation points; and determining an aggregation point in the plurality of aggregation points that aggregates the largest quantity of user locations as the central aggregation point.

For example, GeoHash encoding is first performed on the latitude and longitude coordinates of each user location, the latitude and longitude coordinates are converted into a GeoHash string, and different lengths of GeoHash indicate different geographic location accuracy. During specific implementation, the GeoHash code similarity condition may be determined according to an accuracy requirement of a geofence. Subsequently, according to the set GeoHash code similarity condition, user locations corresponding to GeoHash codes that satisfy the GeoHash code similarity condition are aggregated into one user location category. For example, user locations corresponding to GeoHash codes with the same first ten digits are grouped into one user location category. Further, for each user location category, latitude and longitude coordinates corresponding to the first ten digits of the GeoHash codes of the user locations in the user location category may be used as latitude and longitude coordinates of an aggregation point corresponding to the user location category. Further, a quantity of user locations aggregated into the corresponding user location category is determined according to the first ten digits of the GeoHash codes of the user locations in the user location category, and an aggregation point corresponding to a user location category that aggregates the largest quantity of user locations is used as the central aggregation point.

According to a third aggregation manner, the step of aggregating the user locations according to similarities in latitude and longitude coordinates of the user locations, to determine aggregation points and a central aggregation point includes: dividing a map into uniformly distributed grid squares of preset sizes; aggregating the user locations into corresponding grid squares according to similarities between longitude coordinates of the user locations and longitude coordinates of the grid squares and similarities between latitude coordinates of the user locations and latitude coordinates of the grid squares; determining center points of the grid squares as aggregation points corresponding to the grid squares; and determining an aggregation point in the corresponding grid squares that aggregates the largest quantity of user locations as the central aggregation point.

In some other embodiments of this application, the map on which the geofence is constructed may first be divided into uniformly distributed grid squares of preset sizes, and latitude and longitude coordinates of each grid square are determined. During specific implementation, latitude and longitude coordinates of a center point of the each grid square may be used to identify the latitude and longitude coordinates of the grid square. Subsequently, according to a set grid square latitude and longitude coordinate similarity condition, user locations of which longitude coordinates and longitude coordinates of the grid squares satisfy the grid square latitude and longitude coordinate similarity condition and latitude coordinates and latitude coordinates of the grid squares satisfy the grid square latitude and longitude coordinate similarity condition are aggregated into a corresponding grid square. For example, the grid square latitude and longitude coordinate similarity condition may be as follows: three digits before decimal points of the longitude coordinates are the same, five digits after the decimal points of the longitude coordinates are the same, two digits before decimal points of the latitude coordinates are the same, and five digits after the decimal points of the latitude coordinates are the same. So far, a quantity of user locations aggregated into each grid square is determined. Further, a center point of the each grid square is determined as an aggregation point corresponding to the grid square, and the quantity of user locations aggregated into the grid square is the quantity of user locations aggregated into the corresponding aggregation point. Further, an aggregation point that aggregates the largest quantity of user locations (that is, an aggregation point corresponding to a grid square that aggregates the largest quantity of users) is used as the central aggregation point.

The quantity of user locations aggregated in the aggregation point truly reflects a distribution pattern of the user locations. The aggregation point that aggregates the largest quantity of user locations is selected as the central aggregation point, and a clustering algorithm is simple and efficient, thereby avoiding problems of a mismatch between a clustering result and an actual requirement and an inaccurate geofence because a cluster center and a quantity of cluster categories are manually set.

Step 130. Denoise the aggregation points according to distances between the aggregation points and the central aggregation point.

An aggregation result determined in the foregoing step includes: a plurality of aggregation points and a central aggregation point. In the specific implementation of this application, the user locations are automatically denoised based on the aggregation points and the central aggregation point determined in the foregoing step.

In some embodiments of this application, the step of denoising the aggregation points according to distances between the aggregation points and the central aggregation point includes: determining a user location noise reduction radius according to the distances between the aggregation points and the central aggregation point; and determining an aggregation point of which a distance from the central aggregation point is greater than the user location noise reduction radius as noise for denoising. That is, the user location noise reduction radius is determined according to distribution information of the aggregation points relative to the central aggregation point, and further, the aggregation points are denoised according to the determined user location noise reduction radius, or the user locations are denoised.

The step of determining a user location noise reduction radius according to the distances between the aggregation points and the central aggregation point includes: determining user location distribution regions according to a preset geofence range change step and a distribution range of distances between the aggregation points and the central aggregation point; and determining the user location noise reduction radius based on the central aggregation point according to quantities of aggregation points distributed in the user location distribution regions. First, a geofence range change step is set according to an accuracy requirement of the geofence. For example, when a range of a geofence has a radius of 500 meters, the geofence range change step may be set to 100 meters, the central aggregation point is used as the circle center, and the geofence range change step is used as a radius change step, to determine a circular or annular user location distribution region. According to the data in this example, five user location distribution regions may be determined, namely, a circular user location distribution region with the central aggregation point as the circle center and a radius of 100, an annular user location distribution region between the circular region with the central aggregation point as the circle center and a radius of 100 and a circular region with the central aggregation point as the circle center and a radius of 200, an annular user location distribution region between the circular region with the central aggregation point as the circle center and a radius of 200 and a circular region with the central aggregation point as the circle center and a radius of 300, an annular user location distribution region between the circular region with the central aggregation point as the circle center and a radius of 300 and a circular region with the central aggregation point as the circle center and a radius of 400, and an annular user location distribution region between the circular region with the central aggregation point as the circle center and a radius of 400 and a circular region with the central aggregation point as the circle center and a radius of 500. Subsequently, the distance between each aggregation point and the central aggregation point is calculated, and the distance is used as a radius to determine a circular or annular user location distribution region in which the each aggregation point is distributed. Finally, a maximum radius of a user location distribution region with the largest quantity of aggregation points is used as the user location noise reduction radius based on the central aggregation point. According to a distance of the user location distribution region, if a quantity of aggregation points distributed in the annular user location distribution region between the circular region with the radius of 200 and the circular region with the radius of 300 is the largest among the five user location distribution regions, a maximum radius 300 of the annular user location distribution region is determined as the user location noise reduction radius.

Further, an aggregation point of which a distance from the central aggregation point and the user location noise reduction radius satisfy a preset condition is determined as noise. If the aggregation point of which a distance from the central aggregation point is greater than the user location noise reduction radius is determined as noise, an aggregation point outside a circular region with the central aggregation point as the circle center and a radius of 300 is determined as noise.

In this embodiment, the distances between the aggregation points and the central aggregation point are calculated to determine a maximum distribution radius of the aggregation points, and region division is performed on distribution ranges of the aggregation points according to the preset geofence range change step, to determine a region with the largest quantity of aggregation points, and an upper limit radius of the region is used to determine distribution ranges of noise points, thereby implementing more intelligent and faster denoising to user location data.

In some other embodiments of this application, the step of determining a user location noise reduction radius according to the distances between the aggregation points and the central aggregation point includes: determining an average distance between the aggregation points and the central aggregation point as the user location noise reduction radius. For example, first, a distance between each aggregation point and the central aggregation point is calculated based on latitude and longitude coordinates by using a spherical distance calculation formula, then the average distance between all the aggregation points and the central aggregation point is calculated according to the determined distances, and finally the calculated average distance is used as the user location noise reduction radius.

In some other embodiments of this application, the aggregation points may further be directly denoised according to a preset user location noise reduction radius, and the step of denoising the aggregation points according to distances between the aggregation points and the central aggregation point includes: determining an aggregation point of which a distance from the central aggregation point is greater than the preset user location noise reduction radius as noise for denoising. For example, a construction requirement of a geofence includes a range of the geofence, and a user location noise reduction radius may be preset according to the range of the geofence. During denoising of aggregation points, an aggregation point of which a distance from the central aggregation point is greater than the preset user location noise reduction radius is filtered out as noise.

Step 140. Sort, according to values of longitude coordinates or latitude coordinates, aggregation points obtained after the denoising, to determine geofence boundary data in a preset format.

After the aggregation points are denoised, noise locations are filtered out to obtain effective aggregation points. For all the obtained effective aggregation points, the aggregation points are sorted in an order of values (for example, a descending order or an ascending order) of the longitude coordinates or the latitude coordinates of the aggregation points, and boundary data in a preset format for constructing a geofence is constructed based on the sorted aggregation points. For example, the sorted aggregation points are connected to obtain a boundary of a geofence. In another example, boundary data in a well-known text (WKT) format is constructed based on the sorted aggregation points. For a specific implementation of constructing a geofence based on the boundary data in the WKT format, refer to the related art, and details are not described in the embodiments of this application again.

In the method of determining a geofence based on user locations disclosed in the embodiments of this application, user locations in a plurality of pieces of user data are obtained; the user locations are aggregated according to similarities in latitude and longitude coordinates of the user locations, to determine aggregation points and a central aggregation point; the aggregation points are denoised according to distances between the aggregation points and the central aggregation point; and aggregation points obtained after the denoising are sorted according to values of longitude coordinates or latitude coordinates, to determine geofence boundary data in a preset format. Therefore, a problem of loss of accuracy of a geofence caused by manual intervention to set cluster parameters during clustering of geographic locations in the related art is resolved. In the method of determining a geofence based on user locations disclosed in the embodiments of this application, location aggregation is performed according to the similarities in the latitude and longitude coordinates of the user locations, and effective user location data is automatically determined according to an aggregation result. Subsequently, the boundary data in the preset format is determined based on the effective user location data, thereby obtaining a geofence without any manual intervention, which helps to improve the accuracy of the geofence.

In the specific implementation of this application, aggregated aggregation points are denoised, and geofence boundary data is further constructed based on effective aggregation points obtained after denoising, thereby effectively reducing a data processing amount and improving efficiency of geofence construction. In addition, because the aggregation points are obtained through aggregation based on similarities in latitude and longitude coordinates of user locations, location features of the aggregation points can accurately represent features of the user locations aggregated into the aggregation points, thereby ensuring accuracy of the constructed geofence.

An apparatus of determining a geofence based on user locations disclosed in this embodiment is shown in FIG. 2. The apparatus includes:

a user location obtaining module 210, configured to obtain user locations in a plurality of pieces of user data;

an aggregation module 220, configured to aggregate the user locations according to similarities in latitude and longitude coordinates of the user locations, to determine aggregation points and a central aggregation point;

a denoising module 230, configured to denoise the aggregation points according to distances between the aggregation points and the central aggregation point; and

a geofence construction module 240, configured to sort, according to values of longitude coordinates or latitude coordinates, aggregation points obtained after the denoising, to determine geofence boundary data in a preset format.

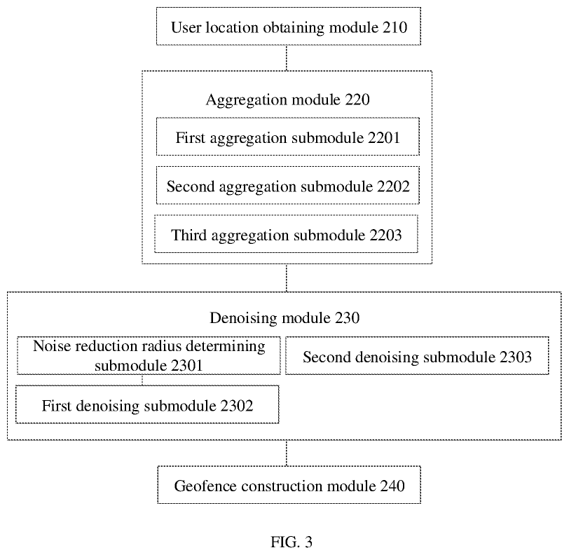

In some embodiments of this application, as shown in FIG. 3, the aggregation module 220 further includes:

a first aggregation submodule 2201, configured to: aggregate user locations that satisfy a preset latitude and longitude coordinate similarity condition into the same aggregation point, to determine a plurality of aggregation points; and determine an aggregation point in the plurality of aggregation points that aggregates the largest quantity of user locations as the central aggregation point, where the preset latitude and longitude coordinate similarity condition is as follows: three digits before decimal points of the longitude coordinates are the same, N digits after the decimal points of the longitude coordinates are the same, two digits before decimal points of the latitude coordinates are the same, and M digits after the decimal points of the latitude coordinates are the same, N and M being positive integers less than or equal to 5. The user locations are directly aggregated based on the latitude and longitude coordinates with the same digits. The aggregation operation has low complexity, fast operation speed, and higher efficiency. In addition, during aggregation based on the similarities in the latitude and longitude coordinates, the latitude and longitude similarity condition can be flexibly and intuitively set according to an application scenario or a construction requirement of a geofence, which is more practical.

In some other embodiments of this application, as shown in FIG. 3, the aggregation module 220 further includes:

a second aggregation submodule 2202, configured to: perform GeoHash conversion on the latitude and longitude coordinates of the user locations, and determine a GeoHash code corresponding to each user location,

the second aggregation submodule 2202 being further configured to: aggregate user locations that satisfy a preset GeoHash code similarity condition into the same aggregation point, to determine a plurality of aggregation points; and determine an aggregation point in the plurality of aggregation points that aggregates the largest quantity of user locations as the central aggregation point.

In some embodiments of this application, as shown in FIG. 3, the aggregation module 220 further includes:

a third aggregation submodule 2203, configured to: divide a map into uniformly distributed grid squares of preset sizes; and aggregate the user locations into corresponding grid squares according to similarities between longitude coordinates of the user locations and longitude coordinates of the grid squares and similarities between latitude coordinates of the user locations and latitude coordinates of the grid squares,

the third aggregation submodule 2203 being configured to: determine center points of the grid squares as aggregation points corresponding to the grid squares; and determine an aggregation point in the corresponding grid squares that aggregates the largest quantity of user locations as the central aggregation point.

In some embodiments of this application, as shown in FIG. 3, the denoising module 230 further includes:

a noise reduction radius determining submodule 2301, configured to determine a user location noise reduction radius according to the distances between the aggregation points and the central aggregation point; and

a first denoising submodule 2302, configured to determine an aggregation point of which a distance from the central aggregation point is greater than the user location noise reduction radius as noise for denoising.

In some other embodiments of this application, the noise reduction radius determining submodule 2301 is further configured to: determine user location distribution regions according to a preset geofence range change step and a distribution range of distances between the aggregation points and the central aggregation point; and determine the user location noise reduction radius based on the central aggregation point according to quantities of aggregation points distributed in the user location distribution regions.

In some other embodiments of this application, the noise reduction radius determining submodule 2301 is further configured to: determine an average distance between the aggregation points and the central aggregation point as the user location noise reduction radius.

In some other embodiments of this application, as shown in FIG. 3, the denoising module 230 further includes:

a second denoising submodule 2303, configured to determine an aggregation point of which a distance from the central aggregation point is greater than a preset user location noise reduction radius as noise for denoising.

In some embodiments of this application, as shown in FIG. 3, the user location obtaining module 210 is further configured to:

obtain, according to creation conditions of a geofence, user data matching the creation conditions; and

obtain a user location in the user data.

The apparatus of determining a geofence based on user locations disclosed in this embodiment is configured to implement the steps of the method of determining a geofence based on user locations described in the embodiments of this application. For the specific implementation of the modules of the apparatus, refer to the corresponding steps. Details are not described herein again.

In the apparatus of determining a geofence based on user locations disclosed in the embodiments of this application, user locations in a plurality of pieces of user data are obtained; the user locations are aggregated according to similarities in latitude and longitude coordinates of the user locations, to determine aggregation points and a central aggregation point; the aggregation points are denoised according to distances between the aggregation points and the central aggregation point; and aggregation points obtained after the denoising are sorted according to values of longitude coordinates or latitude coordinates, to determine geofence boundary data in a preset format. Therefore, a problem of loss of accuracy of a geofence caused by manual intervention to set cluster parameters during clustering of geographic locations in the related art is resolved. In the apparatus of determining a geofence based on user locations disclosed in the embodiments of this application, location aggregation is performed according to the similarities in the latitude and longitude coordinates of the user locations, and effective user location data is automatically determined according to an aggregation result. Subsequently, the boundary data in the preset format is determined based on the effective user location data, thereby obtaining a geofence without any manual intervention, which helps to improve the accuracy of the geofence.

In the specific implementation of this application, aggregated aggregation points are denoised, and geofence boundary data is further constructed based on effective aggregation points obtained after denoising, thereby effectively reducing a data processing amount and improving efficiency of geofence construction. In addition, because the aggregation points are obtained through aggregation based on similarities in latitude coordinates of user locations, location features of the aggregation points can accurately represent features of the user locations aggregated into the aggregation points, thereby ensuring accuracy of the constructed geofence.

Correspondingly, an embodiment of this application further discloses an electronic device, including a memory, a processor, and a computer program stored in the memory and capable of being run on the processor, the processor, when executing the computer program, implementing the method of determining a geofence based on user locations according to the embodiments of this application. The electronic device may be a personal computer (PC), a mobile terminal, a personal digital assistant, a tablet computer, or the like.

An embodiment of this application further discloses a computer-readable storage medium, storing a computer program, the program, when executed by a processor, implementing the steps of the method of determining a geofence based on user locations according to the embodiments of this application.

The embodiments in this specification are all described in a progressive manner. Descriptions of each embodiment focus on differences from other embodiments, and same or similar parts among respective embodiments may be mutually referenced. The apparatus embodiments are substantially similar to the method embodiments and therefore are only briefly described, and reference may be made to the method embodiments for the associated part.

The method of determining a geofence based on user locations provided in this application is described above in detail. Although the principles and implementations of this application are described by using specific examples in this specification, the descriptions of the foregoing embodiments are merely intended to help understand the method and the core idea of the method of this application. Meanwhile, a person of ordinary skill in the art may make modifications to the specific implementations and application range according to the idea of this application. In conclusion, the content of this specification is not construed as a limit on this application.

The foregoing described device embodiments are merely examples. The units described as separate parts may or may not be physically separate, and the parts displayed as units may or may not be physical units, may be located in one location, or may be distributed on a plurality of network units. Some or all of the modules may be selected according to an actual requirement to achieve the objectives of the solutions of the embodiments. A person of ordinary skill in the art may understand and implement the embodiments without creative efforts.

Through the description of the foregoing embodiments, a person skilled in the art may clearly understand that the embodiments may be implemented by software in combination with a universal hardware platform, and may certainly be implemented by hardware, or may be implemented in software modules running on one or more processors. Based on such an understanding, the foregoing technical solutions essentially or the part contributing to the related technology may be implemented in a form of a software product. The computer software product may be stored in a computer-readable storage medium, such as a read-only memory (ROM)/a random access memory (RAM), a magnetic disk, or an optical disc, and include a plurality of instructions for instructing a computer device (which may be a personal computer, a server, a network device, or the like) to perform the methods described in the embodiments or some parts of the embodiments.

A person skilled in the art should understand that a microprocessor or a digital signal processor (DSP) may be used in practice to implement some or all of the functions of some or all of the components in the processing device according to the embodiments of this application. The present disclosure may also be implemented as a device or apparatus program (for example, a computer program and a computer program product) for performing part or all of the methods described herein. Such a program implementing this application may be stored on a computer-readable medium or may have the form of one or more signals. Such signals may be downloaded from Internet websites, provided on carrier signals, or provided in any other form.

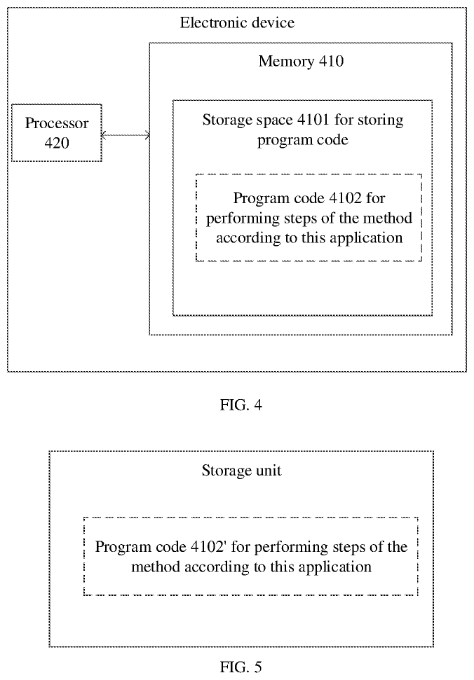

For example, FIG. 4 shows an electronic device that can implement the method according to this application. The electronic device conventionally includes a processor 420 and a computer program product in the form of a memory 410 or a computer-readable medium. The memory 410 may be an electronic memory such as a flash memory, an electrically erasable programmable read-only memory (EEPROM), an EPROM, a hard disk or a ROM. The memory 410 has a storage space 4101 storing program code 4102 used for performing any method step in the foregoing method. For example, the storage space 4101 used for storing program code may include pieces of program code 4102 used for implementing various steps in the foregoing method. The pieces of program code may be read from one or more computer program products or be written to the one or more computer program products. The computer program products include a program code carrier such as a hard disk, a compact disc (CD), a storage card or a floppy disk. Such computer program products are usually portable or fixed storage units as described with reference to FIG. 5. The storage unit may have storage segments, storage spaces, and the like arranged similarly to the storage 420 in the electronic device of FIG. 4. The program code may be, for example, compressed in an appropriate form. Generally, the storage unit includes computer-readable code 4102′, that is, code can be read by, for example, a processor such as the memory 410. When the code is run by the electronic device, the electronic device is caused to perform steps of the foregoing method.

“An embodiment”, “embodiments” or “one or more embodiments” mentioned in the specification means that particular features, structures, or characteristics described with reference to the embodiment are included in at least one embodiment of this application. In addition, it should be noted that the word examples “in an embodiment” herein do not necessarily all refer to the same embodiment.

Numerous specific details are set forth in the specification provided herein. However, it can be understood that, the embodiments of this application may be practiced without the specific details. In some examples, known methods, structures, and technologies are not disclosed in detail, so as not to mix up understanding on the specification.

In the claims, any reference signs placed between parentheses shall not be construed as limiting the claims. The word “include” does not exclude the presence of elements or steps not listed in the claims. The word “a” or “an” preceding an element does not exclude the presence of a plurality of such elements. This application can be implemented by way of hardware including a plurality of different elements and an appropriately programmed computer. In the unit claims enumerating a plurality of apparatuses, the plurality of apparatuses can be specifically embodied by the same item of hardware. The use of the words such as “first”, “second”, “third”, and the like does not denote any order. These words can be interpreted as names.

Finally, it should be noted that the foregoing embodiments are merely intended for describing the technical solutions of this application, but not for limiting this application. Although this application is described in detail with reference to the foregoing embodiments, a person of ordinary skill in the art is to understand that they may still make modifications to the technical solutions described in the foregoing embodiments or make equivalent replacements to some technical features thereof, without departing from the spirit and scope of the technical solutions of the embodiments of this application.

1. A method of determining a geofence based on user locations, comprising:
obtaining user locations in a plurality of pieces of user data;
aggregating the user locations according to similarities in latitude and longitude coordinates of the user locations, to determine aggregation points and a central aggregation point;
denoising the aggregation points according to distances between the aggregation points and the central aggregation point; and
sorting, according to values of longitude coordinates or latitude coordinates, aggregation points obtained after the denoising, to determine geofence boundary data in a preset format.

2. The method according to claim 1, wherein the step of aggregating the user locations according to similarities in latitude and longitude coordinates of the user locations, to determine aggregation points and a central aggregation point comprises:
aggregating user locations that satisfy a preset latitude and longitude coordinate similarity condition into the same aggregation point, to determine a plurality of aggregation points; and
determining an aggregation point in the plurality of aggregation points that aggregates the largest quantity of user locations as the central aggregation point, wherein
the preset latitude and longitude coordinate similarity condition is as follows: three digits before decimal points of the longitude coordinates are the same, N digits after the decimal points of the longitude coordinates are the same, two digits before decimal points of the latitude coordinates are the same, and M digits after the decimal points of the latitude coordinates are the same, N and M being positive integers less than or equal to 5.

3. The method according to claim 1, wherein the step of aggregating the user locations according to similarities in latitude and longitude coordinates of the user locations, to determine aggregation points and a central aggregation point comprises:
performing GeoHash conversion on the latitude and longitude coordinates of the user locations, and determining a GeoHash code corresponding to each user location;
aggregating user locations that satisfy a preset GeoHash code similarity condition into the same aggregation point, to determine a plurality of aggregation points; and
determining an aggregation point in the plurality of aggregation points that aggregates the largest quantity of user locations as the central aggregation point.

4. The method according to claim 1, wherein the step of aggregating the user locations according to similarities in latitude and longitude coordinates of the user locations, to determine aggregation points and a central aggregation point comprises:
dividing a map into uniformly distributed grid squares of preset sizes;
aggregating the user locations into corresponding grid squares according to similarities between longitude coordinates of the user locations and longitude coordinates of the grid squares and similarities between latitude coordinates of the user locations and latitude coordinates of the grid squares;
determining center points of the grid squares as aggregation points corresponding to the grid squares; and
determining an aggregation point in the corresponding grid squares that aggregates the largest quantity of user locations as the central aggregation point.

5. The method according to claim 1, wherein the step of denoising the aggregation points according to distances between the aggregation points and the central aggregation point comprises:
determining a user location noise reduction radius according to the distances between the aggregation points and the central aggregation point; and
determining an aggregation point of which a distance from the central aggregation point is greater than the user location noise reduction radius as noise for denoising.

6. The method according to claim 5, wherein the step of determining a user location noise reduction radius according to the distances between the aggregation points and the central aggregation point comprises:
determining user location distribution regions according to a preset geofence range change step and a distribution range of distances between the aggregation points and the central aggregation point; and
determining the user location noise reduction radius based on the central aggregation point according to quantities of aggregation points distributed in the user location distribution regions.

7. The method according to claim 5, wherein the step of determining a user location noise reduction radius according to the distances between the aggregation points and the central aggregation point comprises:
determining an average distance between the aggregation points and the central aggregation point as the user location noise reduction radius.

8. The method according to claim 1, wherein the step of denoising the aggregation points according to distances between the aggregation points and the central aggregation point comprises:
determining an aggregation point of which a distance from the central aggregation point is greater than a preset user location noise reduction radius as noise for denoising.

9. The method according to claim 1, wherein the step of obtaining user locations in a plurality of pieces of user data comprises:
obtaining, according to creation conditions of a geofence, user data matching the creation conditions; and
obtaining a user location in the user data.

10. An electronic device, comprising a memory, a processor, and a computer program stored in the memory and capable of being run on the processor, the processor, when executing the computer program, implementing the following operations:
obtaining user locations in a plurality of pieces of user data;
aggregating the user locations according to similarities in latitude and longitude coordinates of the user locations, to determine aggregation points and a central aggregation point;
denoising the aggregation points according to distances between the aggregation points and the central aggregation point; and
sorting, according to values of longitude coordinates or latitude coordinates, aggregation points obtained after the denoising, to determine geofence boundary data in a preset format.

11. The electronic device according to claim 10, wherein the operation of aggregating the user locations according to similarities in latitude and longitude coordinates of the user locations, to determine aggregation points and a central aggregation point comprises:
aggregating user locations that satisfy a preset latitude and longitude coordinate similarity condition into the same aggregation point, to determine a plurality of aggregation points; and
determining an aggregation point in the plurality of aggregation points that aggregates the largest quantity of user locations as the central aggregation point, wherein
the preset latitude and longitude coordinate similarity condition is as follows: three digits before decimal points of the longitude coordinates are the same, N digits after the decimal points of the longitude coordinates are the same, two digits before decimal points of the latitude coordinates are the same, and M digits after the decimal points of the latitude coordinates are the same, N and M being positive integers less than or equal to 5.

12. The electronic device according to claim 10, wherein the operation of aggregating the user locations according to similarities in latitude and longitude coordinates of the user locations, to determine aggregation points and a central aggregation point comprises:
performing GeoHash conversion on the latitude and longitude coordinates of the user locations, and determining a GeoHash code corresponding to each user location;
aggregating user locations that satisfy a preset GeoHash code similarity condition into the same aggregation point, to determine a plurality of aggregation points; and
determining an aggregation point in the plurality of aggregation points that aggregates the largest quantity of user locations as the central aggregation point.

13. The electronic device according to claim 10, wherein the operation of aggregating the user locations according to similarities in latitude and longitude coordinates of the user locations, to determine aggregation points and a central aggregation point comprises:
dividing a map into uniformly distributed grid squares of preset sizes;
aggregating the user locations into corresponding grid squares according to similarities between longitude coordinates of the user locations and longitude coordinates of the grid squares and similarities between latitude coordinates of the user locations and latitude coordinates of the grid squares;
determining center points of the grid squares as aggregation points corresponding to the grid squares; and
determining an aggregation point in the corresponding grid squares that aggregates the largest quantity of user locations as the central aggregation point.

14. The electronic device according to claim 10, wherein the operation of denoising the aggregation points according to distances between the aggregation points and the central aggregation point comprises:
determining a user location noise reduction radius according to the distances between the aggregation points and the central aggregation point; and
determining an aggregation point of which a distance from the central aggregation point is greater than the user location noise reduction radius as noise for denoising.

15. A non-volatile computer-readable storage medium, storing a computer program, the program, when executed by a processor, implementing the following operations:
obtaining user locations in a plurality of pieces of user data;
aggregating the user locations according to similarities in latitude and longitude coordinates of the user locations, to determine aggregation points and a central aggregation point;
denoising the aggregation points according to distances between the aggregation points and the central aggregation point; and
sorting, according to values of longitude coordinates or latitude coordinates, aggregation points obtained after the denoising, to determine geofence boundary data in a preset format.

16. The storage medium according to claim 15, wherein the operation of aggregating the user locations according to similarities in latitude and longitude coordinates of the user locations, to determine aggregation points and a central aggregation point comprises:
aggregating user locations that satisfy a preset latitude and longitude coordinate similarity condition into the same aggregation point, to determine a plurality of aggregation points; and
determining an aggregation point in the plurality of aggregation points that aggregates the largest quantity of user locations as the central aggregation point, wherein
the preset latitude and longitude coordinate similarity condition is as follows: three digits before decimal points of the longitude coordinates are the same, N digits after the decimal points of the longitude coordinates are the same, two digits before decimal points of the latitude coordinates are the same, and M digits after the decimal points of the latitude coordinates are the same, N and M being positive integers less than or equal to 5.

17. The storage medium according to claim 15, wherein the operation of aggregating the user locations according to similarities in latitude and longitude coordinates of the user locations, to determine aggregation points and a central aggregation point comprises:
performing GeoHash conversion on the latitude and longitude coordinates of the user locations, and determining a GeoHash code corresponding to each user location;
aggregating user locations that satisfy a preset GeoHash code similarity condition into the same aggregation point, to determine a plurality of aggregation points; and
determining an aggregation point in the plurality of aggregation points that aggregates the largest quantity of user locations as the central aggregation point.

18. The storage medium according to claim 15, wherein the operation of aggregating the user locations according to similarities in latitude and longitude coordinates of the user locations, to determine aggregation points and a central aggregation point comprises:
dividing a map into uniformly distributed grid squares of preset sizes;
aggregating the user locations into corresponding grid squares according to similarities between longitude coordinates of the user locations and longitude coordinates of the grid squares and similarities between latitude coordinates of the user locations and latitude coordinates of the grid squares;
determining center points of the grid squares as aggregation points corresponding to the grid squares; and
determining an aggregation point in the corresponding grid squares that aggregates the largest quantity of user locations as the central aggregation point.

19. The storage medium according to claim 15, wherein the operation of denoising the aggregation points according to distances between the aggregation points and the central aggregation point comprises:
determining a user location noise reduction radius according to the distances between the aggregation points and the central aggregation point; and
determining an aggregation point of which a distance from the central aggregation point is greater than the user location noise reduction radius as noise for denoising.

20. A computer program product, comprising computer-readable code, the computer-readable code, when running on an electronic device, causing the electronic device to perform the method of determining a geofence based on user locations according to claim 1.
